(19) United States
(12) Patent Application Publication
(10) Pub. No.: US 2026/0330365 A1
(43) Pub. Date: Oct. 22, 2026

(54) Modular Artificial Intelligence Orchestration System with Governance-Weighted Runtime Sequence Control, Jurisdictional Compliance Enforcement, and Auditable Attribution

(71) Applicant: Wayne Morris Preston

(72) Inventor: Wayne Morris Preston, North Vancouver (CA)

(73) Assignee: CHASM AI Inc., (omitted)

(21) Appl. No.: 19/645,088

(22) Filed: Apr. 10, 2026

Related U.S. Application Data
(60) Provisional application No. 63/786,982, filed on Apr. 11, 2025.

(51) Int. Cl. G06Q 10/0631; G06F 9/50; G06Q 30/018

(52) U.S. Cl. CPC G06Q 10/06316; G06F 9/5038; G06Q 30/018

(57) ABSTRACT

A modular artificial intelligence orchestration system embeds governance-weighted decision logic into processor-controlled runtime execution. An orchestration controller computes and updates a governance coefficient during execution and rewrites an ordered invocation structure stored in memory to modify scheduling parameters, including module invocation order, module activation state, and output gating conditions, without terminating execution. The system enables reactive runtime restructuring, compliance-aware routing, optional human-in-the-loop escalation, and validated output generation with associated provenance metadata.

### CROSS-REFERENCE TO RELATED APPLICATIONS

This application claims the benefit of U.S. Provisional Patent Application No. 63/786,982, filed Apr. 11, 2025, entitled “ModuLogic AMOS—Agentic Modular Orchestration System for Token-Span-Aware AI Governance, Compliance-Based Execution, and Scalable Content Generation Across Regulated Domains,” the entire disclosure of which is incorporated herein by reference.

### FIELD OF THE INVENTION

The present disclosure relates to artificial intelligence system architectures and, more particularly, to processor-controlled orchestration frameworks that coordinate multiple artificial intelligence modules under governance-weighted runtime control. The disclosed system enables dynamic modification of module execution sequences during active task processing based on compliance conditions, risk thresholds, and jurisdictional requirements without terminating execution of the active task instance.

The invention is applicable to domains including, without limitation, regulated content generation, automated compliance verification, multi-model artificial intelligence orchestration, enterprise workflow automation, and any computational environment in which governance factors must influence runtime execution decisions.

### BACKGROUND OF THE INVENTION

Artificial intelligence deployments frequently involve multiple computational modules operating sequentially or concurrently to accomplish complex tasks. In such multi-module systems, each module may perform a distinct computational function such as content generation, data extraction, classification, summarization, compliance checking, formatting, media composition, or attribution management. The orchestration of these modules—determining which modules execute, in what order, and under what conditions—is a fundamental architectural problem that directly impacts output quality, regulatory compliance, and operational efficiency.

Existing orchestration systems commonly treat module scheduling as a static or performance-optimized workflow. A task enters the system, modules execute in a predetermined sequence, and outputs are produced. Governance concerns such as compliance verification, ethical review, jurisdictional constraints, and risk assessment are typically applied as post-processing steps after the primary computational pipeline has completed. This post-hoc approach introduces several material deficiencies that limit the utility, reliability, and auditability of existing systems.

First, post-generation compliance review introduces latency because the full output must be produced before any governance evaluation occurs. If the output fails compliance checks, the entire generation process may need to be repeated with modified parameters, resulting in wasted computational resources and increased response time. In high-throughput environments processing thousands of tasks per hour, this duplication imposes substantial cost and performance penalties.

Second, post-hoc governance creates inconsistent enforcement because the governance logic operates independently from the execution logic. Changes to compliance requirements may not propagate to the execution layer in a timely or uniform manner, leading to outputs that are generated under stale or misaligned governance rules. This inconsistency is particularly problematic in regulated domains where compliance requirements may change during the pendency of a task—for example, when a jurisdictional constraint is updated while content is being generated for distribution across multiple jurisdictions.

Third, existing systems lack the ability to restructure execution pathways during active task processing. When a compliance condition changes or a risk threshold is exceeded mid-execution, the system cannot modify which modules will execute next, reorder the remaining execution sequence, or insert additional validation steps without terminating and restarting the task. This inability to perform runtime restructuring forces operators to choose between completing a potentially non-compliant execution or aborting and restarting from scratch, neither of which is acceptable in latency-sensitive production environments.

Fourth, audit and provenance tracking in existing systems is often decoupled from the execution control plane. Audit records may capture what outputs were produced but fail to record the governance state that influenced execution decisions, the sequence modifications that occurred during processing, or the causal chain linking governance evaluations to scheduling changes. This gap undermines the ability to reconstruct why a particular execution path was followed, which is a critical requirement for regulatory compliance, forensic analysis, and continuous improvement of governance policies.

Fifth, existing multi-model orchestration systems that coordinate outputs from multiple artificial intelligence models lack mechanisms for resolving conflicting outputs based on governance criteria. When two or more models produce divergent results for the same task, existing systems typically rely on simple majority voting, random selection, or static priority rankings. These resolution mechanisms do not account for the governance context in which each output was produced, leading to selections that may satisfy performance criteria while failing compliance requirements.

Accordingly, there exists a need for modular orchestration architectures in which governance factors are integrated into runtime execution control as first-class control-plane variables rather than applied as post-hoc review layers. There further exists a need for systems capable of dynamically rewriting execution sequences during active task processing, supporting human-in-the-loop escalation with feedback propagation, resolving multi-branch output conflicts using governance-weighted prioritization, and maintaining auditable provenance records that capture the full causal chain of governance-driven execution modifications.

### SUMMARY OF THE INVENTION

Disclosed herein is a modular artificial intelligence orchestration system in which governance-weighted decision logic is embedded directly into processor-controlled module coordination. The system comprises a plurality of functional artificial intelligence modules, an orchestration controller comprising one or more processors and memory, and a governance-weighting engine executed by the orchestration controller.

In one embodiment, the orchestration controller receives a task input, generates a governance weight record in memory comprising at least one compliance coefficient or risk threshold, selects a subset of the plurality of functional artificial intelligence modules, and executes the selected subset according to a module invocation sequence stored in memory as an ordered data structure. The ordered data structure may comprise an array, table, or linked data structure defining the execution order of the selected modules.

During execution of the task input, the orchestration controller computes an updated governance coefficient based on at least one detected compliance or performance condition. The detected compliance condition may comprise a comparison of the governance coefficient to a predefined threshold value stored in memory. The detected performance condition may comprise a deviation in latency, error rate, or output confidence value. Based on the updated governance coefficient, the orchestration controller modifies at least one processor-controlled scheduling parameter by rewriting at least a portion of the ordered data structure stored in memory. The modification may alter the module invocation order, module activation state, or output gating condition. Execution continues under the modified scheduling parameters without terminating the active task instance.

The governance coefficient functions as a control-plane variable that directly alters processor-controlled module routing during runtime. This is distinguished from prior art approaches in which governance evaluation occurs after execution has completed. By embedding governance logic within the execution control plane, the system enables real-time compliance enforcement, reduces rework, and eliminates the latency penalty associated with post-hoc governance review.

In certain embodiments, the system detects compliance or performance conditions during runtime and dynamically restructures execution pathways in response to detected conditions while maintaining the active task instance. The orchestration controller may transition between execution states including a normal execution state and a restructuring state. The restructuring state is triggered in response to a detected deviation in compliance or performance metrics.

In further embodiments, the system integrates human-in-the-loop escalation paths that allow human review or override to modify subsequent orchestration behavior. Escalation to the human review interface may be triggered when a governance coefficient exceeds a predefined threshold. The orchestration controller modifies subsequent execution behavior based on feedback received from a human reviewer, enabling collaborative governance between automated systems and human operators.

Outputs may be validated against governance criteria prior to output propagation. When governance criteria cannot be satisfied, propagation of the output is prevented and the orchestration controller enters a restricted-output state upon detection of a governance violation. Validated outputs may be associated with provenance metadata including execution timestamps, module sequence identifiers, and secure audit records to support traceability and regulatory compliance.

In a further aspect, a non-transitory computer-readable medium stores instructions that, when executed by one or more processors, cause the processors to perform the operations described herein.

### BRIEF DESCRIPTION OF THE DRAWINGS

FIG. 1 is a block diagram illustrating an example governance-weighted modular artificial intelligence orchestration system (100) including a processor system, task intake, governance engine, invocation sequence object, scheduler, module set, output control, validation module, audit store, and human review interface.

FIG. 2 is a diagram illustrating an example memory architecture (200) for governance-weighted runtime scheduling, including a task instance, invocation sequence object with ordered module entries, branch state data, scheduling entries, governance value field, threshold state field, rewrite record field, and associated scheduler, governance engine, validation insert, and audit store components.

FIG. 3 is a flow diagram illustrating governance-weighted runtime restructuring (300) including an active task instance, current invocation sequence evaluation, governance evaluation, threshold determination, invocation sequence rewriting, validation module insertion, downstream module resequencing, modified scheduling state, continued execution, and audit provenance recording.

FIG. 4 is a flow diagram illustrating parallel branch execution with governance-weighted conflict resolution (400) including parallel branch outputs, branch-specific governance weights, conflict evaluation, resolution condition determination, branch output selection, downstream sequence rewriting or merging, continued execution, and audit provenance recording.

FIG. 5 is a flow diagram illustrating output control evaluation and restricted-output state management (500) including generated output evaluation, restricted output condition detection, restricted output state entry, review bundle generation, human review package assembly, human review processing, release condition determination, output release, restricted state maintenance, and audit provenance recording.

FIG. 6 is a diagram illustrating provenance record assembly (600) for runtime rewrite events including pre-rewrite sequence state, post-rewrite sequence state, governance and threshold data, scheduling change data, module and branch identifiers, review linkage data, provenance record assembly, and completed audit provenance records.

FIG. 7 is a block diagram illustrating a Multi-Sphere Processor (MSP) module stack (700) including pre-generation, active generation, and post-generation stages with specific module identifiers for LaunchPad, FlyCatcher, DNA Mapper, TraitMap, InkEngine, HITL InsightPulse, ETHIChekIQ, AI Media Composer, and RoyaltiVault.

FIG. 8 is a diagram illustrating token epoch segmentation (800) including multiple token stream epochs, anchor identifier assignment, semantic state checkpointing, entropy threshold detection, partial rollback initiation, and context rehydration within an orchestration session.

FIG. 9 is a diagram illustrating an orchestration trace ledger structure (900) including ledger records with session identifiers, anchor identifier links, module identifiers, governance values, rewrite event logs, token epoch anchors, distributed ledger registry, and cryptographic hash verification for deterministic session reconstruction.

### DETAILED DESCRIPTION OF THE INVENTION

The following detailed description sets forth specific embodiments of the disclosed modular artificial intelligence orchestration system. The description references the accompanying drawings, in which like reference numerals refer to like elements throughout. The embodiments described herein are illustrative and not limiting. Variations and modifications will be apparent to those skilled in the art without departing from the scope of the appended claims.

As used herein, the term “governance coefficient” refers to a numerical value computed by the governance-weighting engine that quantifies the current compliance, risk, or governance posture of an active task instance. The governance coefficient may be a scalar value, a vector of values, or a composite score derived from multiple input factors. The governance coefficient is distinguished from static configuration parameters in that it is computed and updated during runtime execution based on detected conditions.

As used herein, the term “invocation sequence object” refers to an ordered data structure stored in memory that defines the execution order and activation states of modules selected for a given task instance. The invocation sequence object is subject to runtime rewriting by the orchestration controller. The ordered data structure may be implemented as an array, a table, a linked list, a priority queue, or any functionally equivalent data structure that maintains an ordered relationship among its entries.

As used herein, the term “rewriting” refers to the modification of the invocation sequence object in memory during active task execution. Rewriting operations include, without limitation: reordering module identifiers within the data structure, inserting supplemental module identifiers into the data structure, removing module identifiers from the data structure, clearing activation flags to disable modules, setting activation flags to enable previously disabled modules, and modifying output gating conditions associated with individual modules.

As used herein, the term “scheduling parameter” refers to a processor-controlled variable that governs module dispatch by the scheduler. Scheduling parameters include, without limitation: module invocation order, module activation state, output gating conditions, execution priority values, concurrency constraints, and timeout thresholds.

### System Architecture Overview

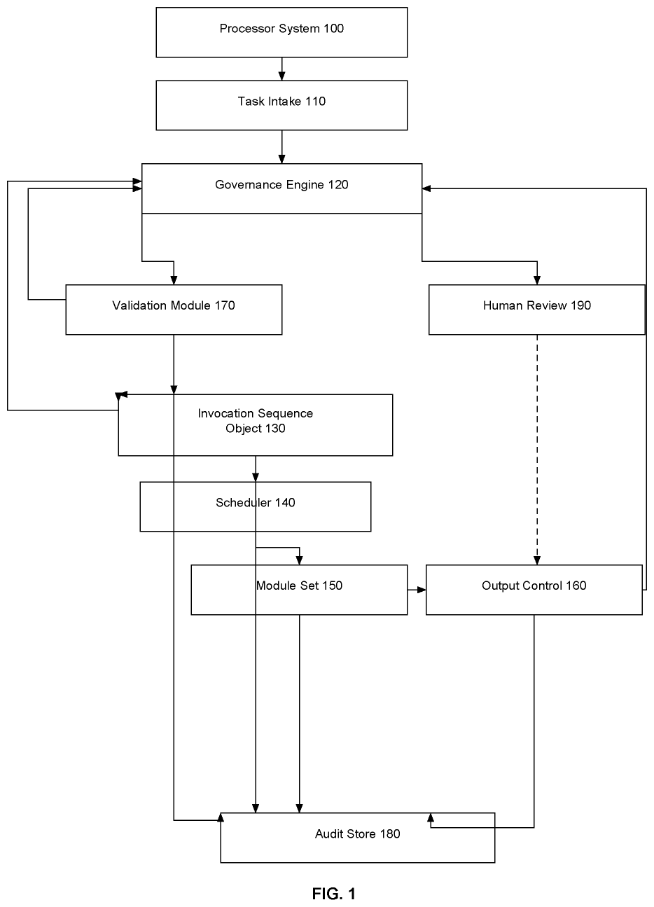

Referring now to FIG. 1, an example governance-weighted modular artificial intelligence orchestration system (100) is illustrated. The system comprises a processor system (100) that includes one or more processors and memory storing instructions executable by the one or more processors. The processor system may be implemented using general-purpose processors, graphics processing units, application-specific integrated circuits, field-programmable gate arrays, or any combination thereof. The memory may comprise volatile memory such as random-access memory, non-volatile memory such as solid-state storage, or a combination of both.

A task intake component (110) receives task inputs from external sources such as application programming interfaces, user interfaces, message queues, event streams, or automated triggers. Each task input initiates an orchestration session that is tracked throughout the system by a unique session identifier. The task input may include structured data, unstructured text, media content, configuration parameters, or any combination thereof. The task intake component (110) performs initial validation of the task input format and routes the validated input to the orchestration controller for processing.

A governance engine (120) is executed by the processor system and implements governance-weighted decision logic. The governance engine (120) computes and maintains a governance coefficient associated with each active task instance. The governance coefficient is a numerical value derived from one or more compliance conditions, risk thresholds, jurisdictional indicators, or override states. The governance coefficient functions as a control-plane variable that directly influences processor-controlled module routing decisions during runtime execution. The governance engine (120) evaluates compliance conditions by comparing current execution state against stored compliance rules, regulatory requirements, content policies, or contractual obligations.

The governance engine (120) generates a governance weight record in memory comprising at least one compliance coefficient and at least one risk threshold. In certain embodiments, the governance weight record further comprises a jurisdiction indicator that identifies the regulatory jurisdiction applicable to the current task, enabling jurisdiction-specific compliance enforcement. In certain embodiments, the governance weight record further comprises an override state that indicates whether a human operator has overridden automated governance decisions for the current task instance.

An invocation sequence object (130) is stored in memory as an ordered data structure that defines the execution order of selected modules for a given task instance. The ordered data structure may comprise at least one of an array, a table, or a linked data structure. Each entry in the invocation sequence object (130) identifies a module by a unique module identifier, the module's current activation state (active or inactive), an execution priority value, any prerequisite conditions that must be satisfied before the module executes, and any output gating conditions that must be satisfied before the module's output is propagated downstream. The invocation sequence object (130) is not static; it is subject to runtime rewriting by the governance engine (120) and scheduler (140) based on governance coefficient updates.

A scheduler (140) reads the invocation sequence object (130) and dispatches module executions according to the ordering, activation states, and gating conditions defined therein. The scheduler (140) implements processor-controlled scheduling parameters including module invocation order, module activation state, and output gating conditions. When the governance engine (120) determines that a scheduling parameter must be modified, the scheduler (140) cooperates with the governance engine to rewrite the invocation sequence object (130) in memory. The rewrite operation modifies the stored data structure without terminating the active task instance, enabling continuous execution under modified governance parameters.

A module set (150) comprises a plurality of functional artificial intelligence modules, each configured to perform a defined computational task. Individual modules may perform functions such as content generation, data extraction, entity recognition, classification, summarization, compliance verification, formatting, translation, sentiment analysis, media composition, or attribution management. The orchestration controller selects a subset of the module set (150) for each task based on the task input characteristics, the applicable governance requirements, and the available module capabilities. Each module operates as a self-contained computational unit with defined input and output interfaces, enabling modules to be added, removed, replaced, or reordered without modifying the core orchestration logic.

An output control component (160) evaluates candidate outputs against governance criteria prior to output propagation. The output control component (160) applies the governance criteria specified in the governance weight record to each candidate output. If all applicable governance criteria are satisfied, the output is released for propagation to the task requester or downstream systems. If one or more governance criteria cannot be satisfied, the output control component (160) prevents propagation of the output and transitions the system to a restricted-output state. The restricted-output state ensures that non-compliant outputs are never propagated without explicit human authorization.

A validation module (170) performs additional compliance verification as directed by the governance engine (120). The validation module (170) may be dynamically inserted into the invocation sequence during runtime when a governance coefficient indicates that additional validation is required. This insertion is accomplished by rewriting the invocation sequence object (130) to include the validation module (170) at the appropriate position in the execution sequence. The dynamic insertion capability enables the system to add governance checkpoints in response to detected conditions without requiring a predefined validation schedule.

An audit store (180) records provenance metadata associated with each orchestration session. The provenance metadata includes execution timestamps, module sequence identifiers, governance coefficient values at each decision point, pre-rewrite and post-rewrite invocation sequence states, threshold conditions that triggered rewrite events, scheduling deltas applied during each rewrite, branch identifiers for concurrent execution paths, and human review linkage data. The audit store (180) supports deterministic reconstruction of the complete execution path for regulatory compliance, forensic analysis, and continuous improvement of governance policies.

A human review interface (190) receives intermediate outputs when a governance coefficient exceeds a predefined escalation threshold. The human review interface (190) enables human reviewers to examine intermediate results, provide feedback, approve continuation, modify parameters, or override governance decisions. Feedback received from a human reviewer is propagated back to the governance engine (120), which may modify subsequent execution behavior based on the reviewer's input. This bidirectional feedback loop enables collaborative governance between automated systems and human operators, ensuring that human judgment can be applied at critical decision points without requiring human involvement in every execution step.

### Memory Architecture and Data Structures

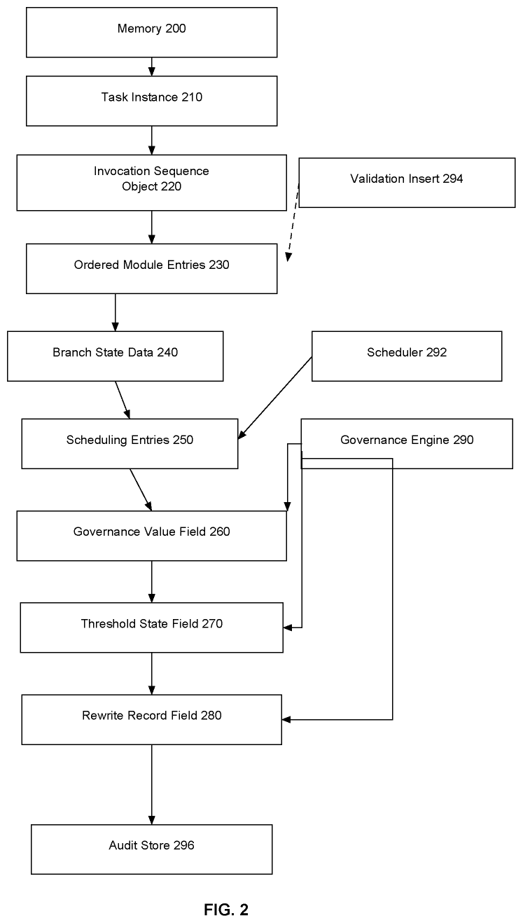

Referring now to FIG. 2, an example memory architecture (200) for governance-weighted runtime scheduling is illustrated in detail. The memory architecture defines the data structures that enable runtime rewriting of execution sequences and governance-weighted scheduling control.

A task instance (210) is instantiated in memory for each active orchestration session. The task instance (210) maintains state information throughout execution including the task input data, the current execution phase, accumulated intermediate results, error conditions, and session metadata. The task instance (210) persists in memory until the task is completed, aborted, or archived to persistent storage.

An invocation sequence object (220) is stored in memory and contains ordered module entries (230) that define the execution sequence for the active task. Each entry in the ordered module entries (230) includes a module identifier, an execution priority value, an activation flag indicating whether the module is currently enabled, prerequisite condition identifiers, and output gating condition identifiers. The ordered module entries (230) are implemented as an ordered data structure—specifically, as at least one of an array, a table, or a linked data structure—that maintains the relative execution order of the selected modules.

The activation flag within each entry is a binary value that indicates whether the module is eligible for execution. Rewriting the invocation sequence may comprise clearing an activation flag to disable a module, effectively removing it from the execution path without deleting its entry from the data structure. This approach preserves the ability to re-enable the module later during the same task execution if conditions change.

Branch state data (240) is maintained in memory when the orchestration controller dispatches a task into parallel execution branches. Each branch maintains its own invocation sequence and governance state, enabling independent execution paths that can be monitored, modified, and resolved separately. Branch state data (240) enables the system to track concurrent execution paths and resolve conflicts between branch outputs using governance-weighted prioritization.

Scheduling entries (250) store the current scheduling parameters that control module dispatch. These parameters include module invocation order as defined by the ordered module entries (230), activation states for each module, timing constraints, concurrency limits, and resource allocation preferences. The scheduling entries (250) are directly modified when the governance engine triggers a rewrite operation, and the modifications take effect immediately for subsequent module dispatches within the same task instance.

A governance value field (260) stores the current governance coefficient for the active task instance. The governance coefficient is a numerical value that may be updated multiple times during execution as new compliance or performance conditions are detected. The governance value field (260) is read by the scheduler (292) and governance engine (290) when making routing decisions. Each update to the governance value field (260) is recorded with a timestamp to support audit trail reconstruction.

A threshold state field (270) stores predefined threshold values against which the governance coefficient is compared. These thresholds define boundaries for normal operation, escalation triggers, restricted-output conditions, and human review requirements. Multiple threshold values may be stored, each associated with a different governance action. When the governance coefficient crosses a threshold boundary, the system transitions between execution states and may initiate a rewrite of the invocation sequence.

A rewrite record field (280) captures a log of all modifications made to the invocation sequence object during execution. Each rewrite record includes the pre-rewrite sequence state (a snapshot of the ordered data structure before modification), the post-rewrite sequence state (a snapshot after modification), the threshold identifier that triggered the rewrite, the scheduling delta applied (a description of the specific changes made), the branch identifier if the rewrite affected a specific branch, a timestamp, and any human-review linkage data. This information is propagated to the audit store (296) for provenance tracking and enables deterministic reconstruction of the modification history.

The governance engine (290), scheduler (292), validation insert (294), and audit store (296) operate as interconnected components within the memory architecture, reading from and writing to the shared data structures described above. The governance engine (290) computes governance coefficient updates and determines when rewrite operations are necessary. The scheduler (292) executes rewrite operations against the invocation sequence object and dispatches modules according to the modified schedule. The validation insert (294) manages the dynamic insertion of validation modules into the execution sequence. The audit store (296) persistently records all governance events, rewrite operations, and provenance metadata.

### Governance-Weighted Runtime Restructuring

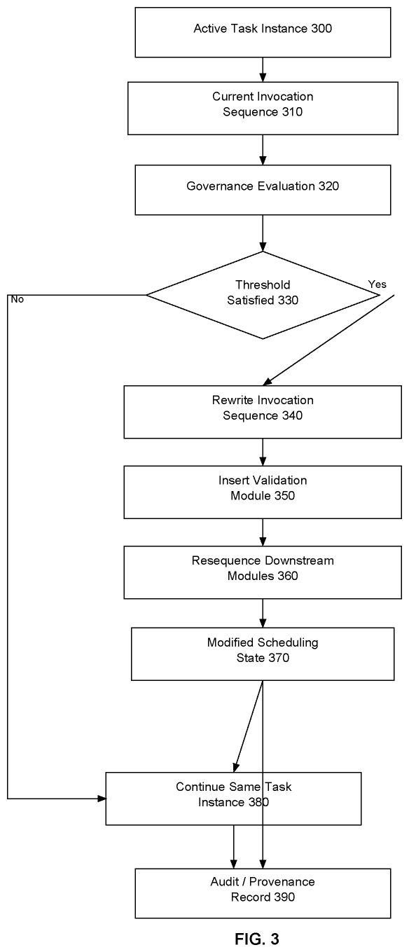

Referring now to FIG. 3, an example governance-weighted runtime restructuring procedure (300) is illustrated as a flow diagram. This procedure enables the system to modify execution pathways during active task processing without terminating the task instance—a capability referred to herein as self-adaptive structuring (SAS).

An active task instance (300) is executing under the current invocation sequence (310). Modules are being dispatched and executed according to the ordered data structure stored in memory. During execution, a governance evaluation (320) is performed by the governance engine. The governance evaluation computes or updates the governance coefficient based on detected compliance or performance conditions. The governance coefficient may be recalculated at least once during execution of the task input, and in certain embodiments is recalculated while at least one module of the selected subset remains active.

A threshold determination (330) compares the updated governance coefficient against predefined threshold values stored in the threshold state field (270 of FIG. 2). If the threshold is satisfied—meaning the governance coefficient remains within acceptable bounds—execution continues under the existing invocation sequence without modification. The flow returns to the governance evaluation step (320) for continued monitoring.

If the threshold is not satisfied—meaning the governance coefficient has crossed a threshold boundary indicating a compliance deviation or performance degradation—the system initiates a rewrite of the invocation sequence (340). The rewrite operation modifies the ordered data structure stored in memory. Rewriting may comprise one or more of the following operations: reordering module identifiers within an array stored in memory to change the execution sequence; inserting a supplemental module identifier into the ordered data structure to add a new processing step; or clearing an activation flag to disable a module within the ordered data structure, effectively bypassing it in the execution sequence.

A validation module insertion step (350) may add a validation module at the appropriate position in the rewritten sequence when the governance evaluation indicates that additional compliance verification is required. The insertion point is determined by the governance engine based on the nature of the detected condition and the modules remaining in the execution sequence.

Downstream modules are resequenced (360) to accommodate any inserted modules and any reordering operations. The resequencing ensures that prerequisite conditions and data flow dependencies are maintained after the modification. The modified scheduling state (370) is committed to memory by updating the scheduling entries (250 of FIG. 2), and execution continues (380) under the modified parameters on the same active task instance without termination.

An audit provenance record (390) captures the entire rewrite event including the pre-rewrite sequence state, the post-rewrite sequence state, the governance coefficient value that triggered the rewrite, the threshold that was exceeded, the specific scheduling changes applied, and a timestamp. This record is stored in the audit store for subsequent retrieval and analysis.

### Parallel Branch Execution and Conflict Resolution

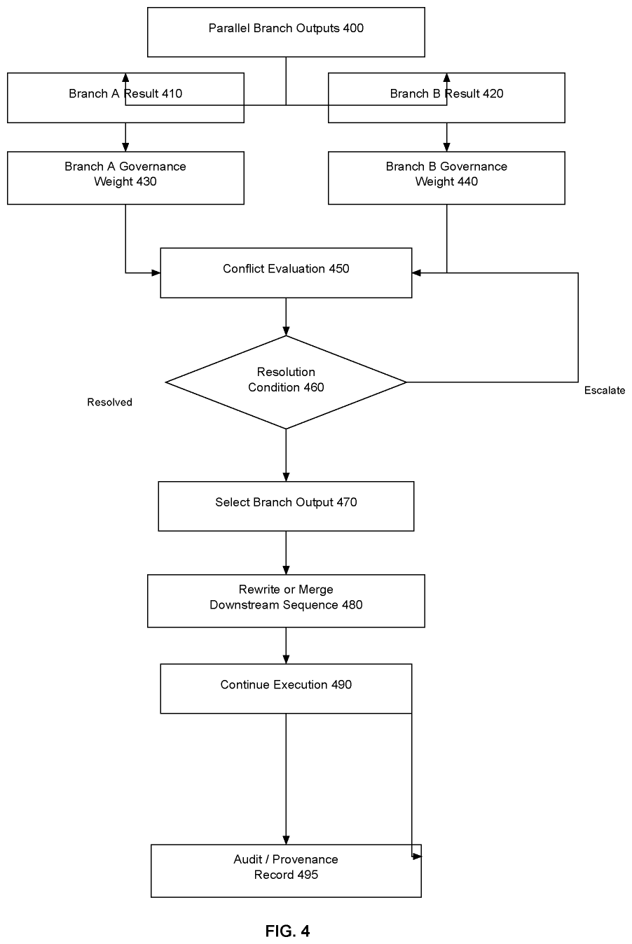

Referring now to FIG. 4, an example parallel branch execution with governance-weighted conflict resolution (400) is illustrated. The system supports concurrent execution in which at least two modules are concurrently active and execute in overlapping time intervals. When the orchestration controller dispatches a task into parallel branches, each branch produces independent outputs that may subsequently require reconciliation.

Parallel branch outputs (400) include a branch A result (410) and a branch B result (420). Each branch is associated with a branch-specific governance weight computed during that branch's execution: branch A governance weight (430) and branch B governance weight (440). The governance weights reflect the compliance conditions, risk assessments, and performance characteristics evaluated during each branch's independent execution path.

A conflict evaluation (450) examines the branch outputs when they produce conflicting or divergent results. Conflicts may arise when different modules or different model instances produce contradictory outputs, when outputs satisfy different subsets of governance criteria, or when performance metrics differ significantly between branches.

A resolution condition (460) determines whether the conflict can be resolved automatically through governance-weighted prioritization or requires escalation to human review. When the resolution condition indicates automatic resolution is possible, the system selects a branch output (470) using governance-weighted prioritization. Under governance-weighted prioritization, the branch output associated with the higher governance weight—indicating greater compliance satisfaction and lower risk—is preferred for downstream processing. This approach ensures that conflict resolution decisions account for governance context rather than relying on arbitrary selection mechanisms.

The downstream invocation sequence is rewritten or merged (480) based on the selected branch output. The rewrite operation updates the ordered data structure in memory to reflect the selected execution path. Execution continues (490) under the modified sequence. An audit provenance record (495) captures the conflict resolution decision, the governance weights of each branch, the resolution method applied, and the rationale for the selected output.

### Output Control and Restricted-Output State Management

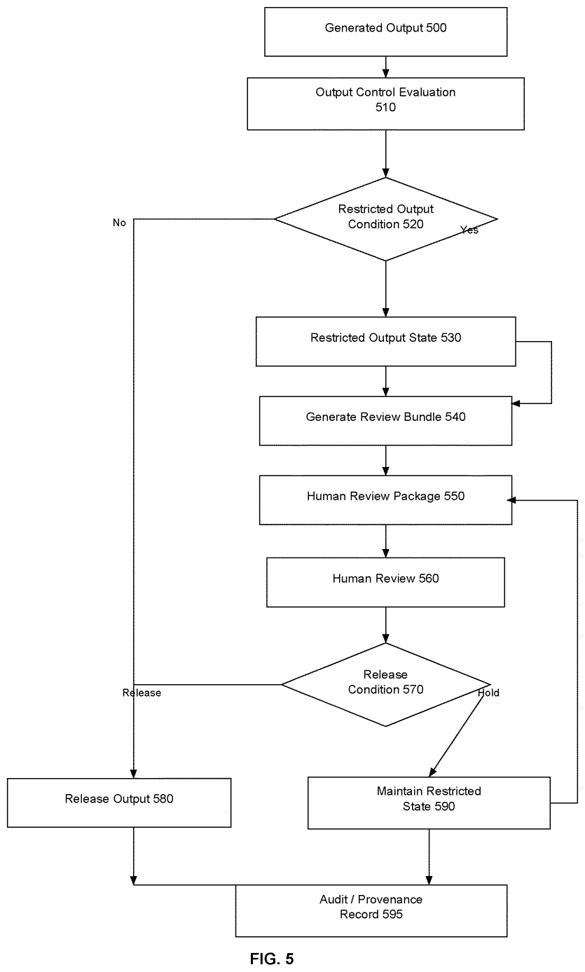

Referring now to FIG. 5, an example output control evaluation and restricted-output state management procedure (500) is illustrated. This procedure ensures that outputs are validated against governance criteria before being propagated to the task requester or downstream systems.

When a generated output (500) is produced by the module pipeline, an output control evaluation (510) assesses whether the output satisfies all applicable governance criteria. The evaluation applies the compliance rules, risk thresholds, jurisdictional requirements, and content policies specified in the governance weight record to the candidate output.

If a restricted output condition (520) is detected-- meaning that one or more governance criteria cannot be satisfied by the candidate output-- the system transitions to a restricted output state (530). In the restricted output state, propagation of the output is prevented. The orchestration controller enters the restricted-output state upon detection of the governance violation, ensuring that non-compliant outputs cannot reach the task requester without explicit human authorization.

A review bundle (540) is generated containing the candidate output, the governance evaluation results, the specific criteria that were not satisfied, and supporting context including the governance coefficient history and the invocation sequence that produced the output. A human review package (550) is assembled from the review bundle and presented to the human review interface for human review (560).

The human reviewer examines the candidate output and the governance evaluation results. A release condition evaluation (570) determines the outcome based on the reviewer's decision: if the reviewer authorizes release, the output is released (580) for propagation; if the reviewer does not authorize release, the system maintains the restricted state (590) and the output is not propagated. An audit provenance record (595) captures the entire output control evaluation, the restricted-state entry, the human review decision, the reviewer's identity, and the final disposition of the output.

### Provenance Record Assembly and Audit Trail

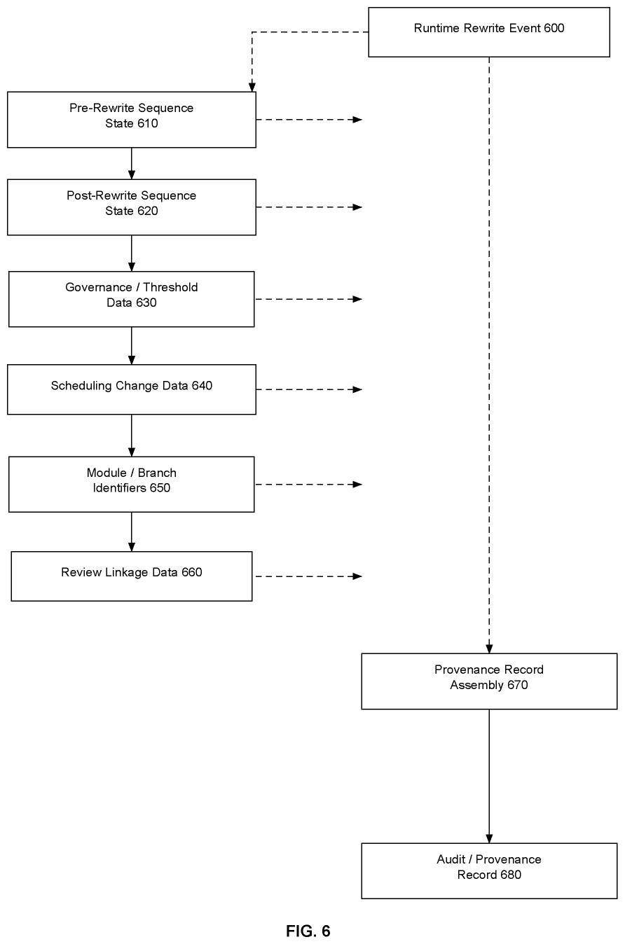

Referring now to FIG. 6, an example provenance record assembly procedure (600) for a runtime rewrite event is illustrated. The provenance system is designed to capture sufficient information to enable deterministic reconstruction of any governance-driven execution modification, supporting regulatory audit, forensic analysis, and compliance verification.

Each time the invocation sequence is rewritten during execution, a provenance record is assembled from multiple data sources. The pre-rewrite sequence state (610) captures a complete snapshot of the invocation sequence object as it existed before the modification, including all module identifiers, activation states, and gating conditions. The post-rewrite sequence state (620) captures a complete snapshot of the invocation sequence object after the modification has been applied.

Governance and threshold data (630) records the governance coefficient values at the time of the rewrite, the specific threshold that was exceeded, and the compliance or performance condition that triggered the threshold crossing. Scheduling change data (640) records the specific scheduling parameters that were modified, including module order changes, activation state changes, gating condition updates, and any timing constraint modifications.

Module and branch identifiers (650) record which modules were affected by the rewrite and, in the case of concurrent execution, which branch the rewrite affected. Review linkage data (660) records any association between the rewrite event and human review actions, enabling the audit trail to connect automated governance decisions with human oversight activities.

A provenance record assembly step (670) consolidates all of these data elements into a unified audit provenance record (680) that is stored in the audit store. The provenance record supports deterministic reconstruction of any rewrite event, enabling operators and auditors to trace the complete causal chain from a governance condition detection through the resulting execution modification and its downstream effects on task output.

### Multi-Sphere Processor Module Stack Implementation

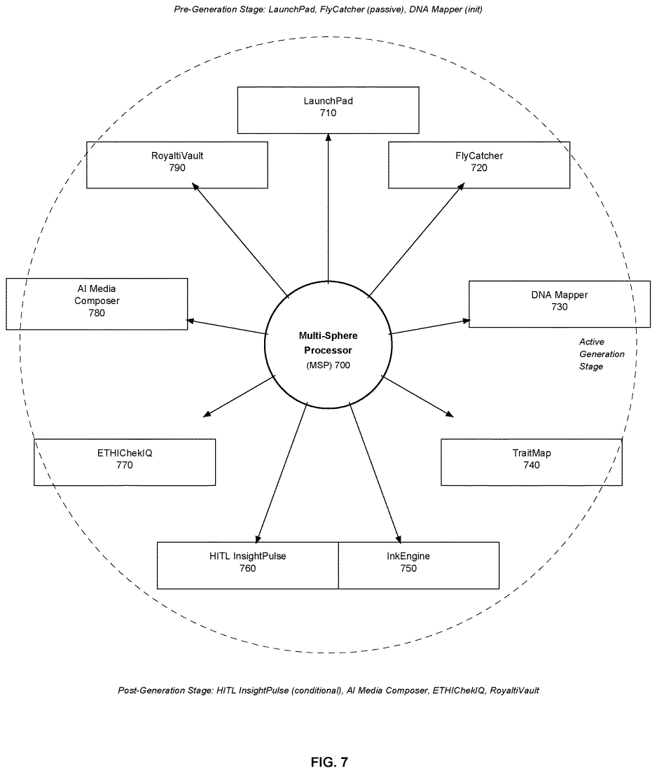

Referring now to FIG. 7, an example Multi-Sphere Processor (MSP) module stack (700) is illustrated as a specific implementation embodiment of the disclosed orchestration system. The MSP organizes the plurality of functional AI modules into three execution stages: a pre-generation stage, an active generation stage, and a post-generation stage. This three-stage organization demonstrates how the governance-weighted orchestration architecture accommodates domain-specific module configurations.

The pre-generation stage comprises LaunchPad (710), which performs task initialization, parameter configuration, and governance weight record generation; FlyCatcher (720), which operates in a passive monitoring mode during pre-generation, collecting metadata and environmental signals that inform subsequent governance evaluations; and DNA Mapper (730), which performs initial data mapping, structure initialization, and input normalization to prepare the task data for active generation.

The active generation stage comprises TraitMap (740), which performs characteristic mapping, feature extraction, and content structuring; and InkEngine (750), which performs the primary content generation and transformation operations. These modules operate under direct governance control, with the governance engine monitoring their outputs and modifying the invocation sequence as needed based on real-time governance coefficient evaluation. The active generation stage is where the majority of runtime restructuring events occur, as the governance engine evaluates intermediate outputs and adjusts the execution pathway in response to detected conditions.

The post-generation stage comprises HITL InsightPulse (760), which provides conditional human-in-the-loop review capabilities and is activated only when the governance coefficient exceeds the escalation threshold; ETHIChekIQ (770), which performs ethical and compliance verification against applicable regulatory frameworks; AI Media Composer (780), which handles media composition, formatting, and output assembly; and RoyaltiVault (790), which manages attribution, licensing, provenance metadata generation, and rights management.

The MSP module stack demonstrates that the disclosed orchestration architecture supports specialized module pipelines while maintaining the governance-weighted control-plane architecture described throughout this specification. Different deployment domains may substitute, add, or remove modules from the stack while preserving the core governance-weighted scheduling and runtime restructuring capabilities. The modular architecture ensures that the governance engine, scheduler, and audit store operate independently of the specific modules in the pipeline.

### Token Epoch Segmentation and Context Management

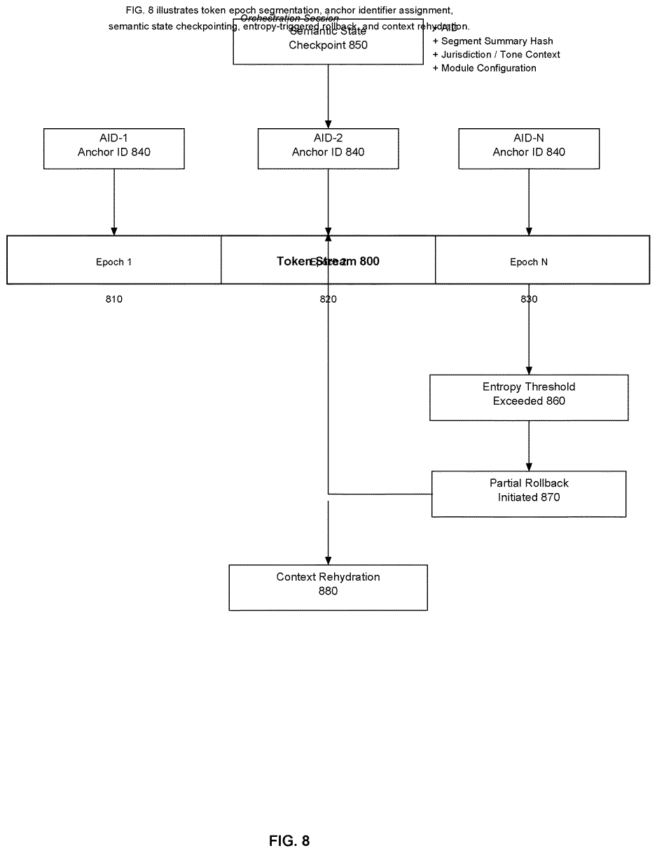

Referring now to FIG. 8, an example token epoch segmentation architecture (800) is illustrated. In embodiments where one or more modules process token-based data streams—such as large language model outputs, streaming text generation, or sequential data processing—the orchestration system segments the token stream into discrete epochs to enable fine-grained governance control and rollback capabilities.

Epoch 1 (810), Epoch 2 (820), and subsequent epochs through Epoch N (830) each represent a bounded segment of the token stream. Epoch boundaries may be defined by token count thresholds, semantic boundaries detected in the output content, governance evaluation points, or time-based intervals. The epoch segmentation enables the system to apply governance evaluations at sub-task granularity rather than waiting for the complete output to be generated.

Each epoch is assigned an anchor identifier (AID) (840) that uniquely identifies the epoch within the orchestration session. The anchor identifier serves as a cross-reference key that links token stream positions to governance events, audit records, rewrite operations, and provenance metadata. The anchor identifier enables precise identification of which portion of the token stream was affected by a particular governance decision or execution modification.

A semantic state checkpoint (850) is created at epoch boundaries. Each checkpoint records the anchor identifier, a segment summary hash that captures the content state at the checkpoint, jurisdiction and tone context applicable to the epoch, and the module configuration active during that epoch. The semantic state checkpoints enable the system to establish known-good states throughout the execution timeline.

When an entropy threshold is exceeded (860)—indicating that output quality, coherence, compliance alignment, or confidence has degraded beyond acceptable bounds as determined by the governance engine—a partial rollback (870) is initiated. The partial rollback returns the system state to the most recent semantic state checkpoint that satisfies governance requirements. This targeted rollback avoids the need to restart the entire task from the beginning, preserving the computational work performed prior to the degradation point.

Context rehydration (880) then restores the necessary context from the selected checkpoint, including intermediate results, governance state, and module configuration. Execution resumes from the rolled-back position using the restored context, enabling the system to recover from quality degradation events while maintaining continuity of the active task instance.

### Orchestration Trace Ledger and Immutable Audit Records

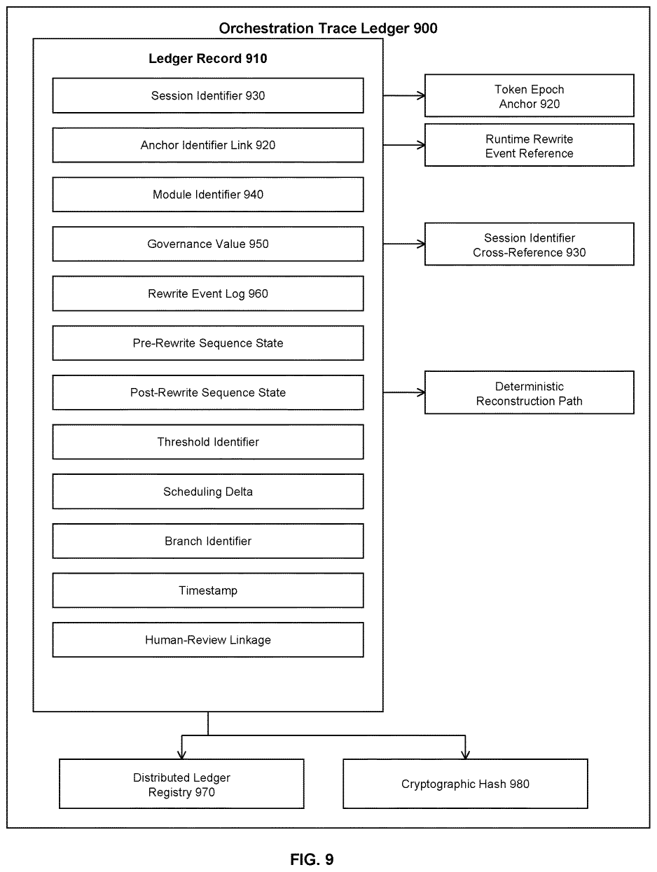

Referring now to FIG. 9, an example orchestration trace ledger structure (900) is illustrated. The orchestration trace ledger provides a comprehensive, immutable record of all orchestration events within a session, enabling deterministic reconstruction of the complete execution history for regulatory compliance, forensic analysis, and dispute resolution.

Each ledger record (910) contains multiple data fields that together capture the complete governance and execution state at a specific point in the orchestration session. The ledger record includes a token epoch anchor link (920) connecting the record to the token stream epoch described in FIG. 8; a session identifier (930) uniquely identifying the orchestration session across the system; a module identifier (940) indicating which module was active at the time of the event; and a governance value (950) recording the governance coefficient at the time the event occurred.

A rewrite event log (960) within each ledger record captures the complete details of any invocation sequence modification that occurred at the recorded event. The rewrite event log includes the pre-rewrite sequence state, the post-rewrite sequence state, the threshold identifier that triggered the rewrite, the scheduling delta applied, the branch identifier if the event involved concurrent execution, a timestamp, and human-review linkage data if the event involved human escalation or override.

A distributed ledger registry (970) may be used to register ledger records in an external tamper-evident storage system. The distributed ledger registry provides an additional layer of integrity assurance beyond the internal audit store by publishing record hashes to a distributed, append-only ledger that is not controlled by the orchestration system operator. Each registration is associated with a cryptographic hash (980) that ensures the integrity and immutability of the record. Any subsequent modification of a registered record would invalidate the cryptographic hash, providing tamper evidence.

The combination of session identifier cross-referencing (930), anchor identifier linkage (920), and cryptographic hash verification (980) enables a deterministic reconstruction path through which any orchestration session can be fully replayed and audited. An auditor can retrieve the session's ledger records, verify their integrity through cryptographic hash comparison, and reconstruct the complete sequence of governance evaluations, rewrite events, human review interactions, and output dispositions that occurred during the session.

### Additional Embodiments

In certain embodiments, one or more modules of the modular orchestration pipeline are executed within a containerized runtime environment. The containerized runtime environment may comprise one or more container instances, each encapsulating a single module or a group of related modules together with their runtime dependencies. Container images corresponding to the functional modules may be built and deployed using continuous integration and continuous deployment pipelines that perform automated testing and validation prior to deployment.

The containerized runtime environment may be implemented using container orchestration platforms and may be deployed in public cloud, private cloud, hybrid cloud, or on-premises infrastructure. In certain embodiments, secrets and credentials used by one or more modules are managed via a secrets manager and injected at runtime under access-control policy. Access to internal configuration surfaces, module health endpoints, and administrative interfaces may be restricted by network-layer controls.

In certain embodiments, observability data including logs, metrics, and traces are recorded in association with an orchestration session identifier and one or more content anchor identifiers. The observability data may be stored using structured logging formats and may be queried using centralized log aggregation and analysis systems. The observability data supplements the provenance metadata stored in the audit store and provides operational visibility into system health and performance.

The governance coefficient may be recalculated at multiple points during execution of a single task instance. In certain embodiments, the governance coefficient is recalculated while at least one module of the selected subset remains active, enabling real-time adjustment of the execution pathway without waiting for all active modules to complete. This continuous recalculation capability ensures that governance enforcement is responsive to changing conditions throughout the execution lifecycle.

In embodiments involving concurrent execution, at least two modules execute in overlapping time intervals. When concurrently active modules produce conflicting outputs, the conflicts are resolved using governance-weighted prioritization in which the module output associated with the higher governance weight is selected for downstream processing. This governance-weighted conflict resolution ensures that compliance considerations take precedence over performance metrics when outputs diverge.

The orchestration controller may transition between execution states including a normal execution state and a restructuring state. The restructuring state is triggered in response to a detected deviation in compliance or performance metrics. During the restructuring state, the invocation sequence object is rewritten, and the system transitions back to the normal execution state once the modification is complete and the modified scheduling parameters have been committed to memory.

The detected compliance condition may comprise a comparison of the governance coefficient to a predefined threshold value stored in memory. The detected performance condition may comprise a deviation in latency, error rate, or output confidence value. Both compliance and performance conditions serve as inputs to the governance evaluation that determines whether a rewrite operation is necessary.

The provenance metadata associated with validated outputs may include an execution timestamp and a module sequence identifier. The provenance metadata may be stored in a secure audit record. The secure audit record may be registered in a distributed ledger with cryptographic hash verification to ensure tamper evidence. The provenance metadata enables downstream consumers of the output to verify the governance conditions under which the output was produced.

The embodiments described herein are provided as non-limiting examples of the disclosed modular artificial intelligence orchestration system. The invention is operable in a variety of computing environments and is not limited to any particular cloud provider, container runtime, secrets management system, observability platform, or hardware architecture. The scope of the invention is defined by the appended claims.

1. A modular artificial intelligence orchestration system comprising: a plurality of functional artificial intelligence modules, each module configured to perform a defined computational task; an orchestration controller comprising one or more processors and memory storing instructions executable by the one or more processors; and a governance-weighting engine executed by the orchestration controller, wherein the orchestration controller is configured to: (a) receive a task input; (b) generate, in memory, a governance weight record comprising at least one compliance coefficient or risk threshold; (c) select a subset of the plurality of functional artificial intelligence modules; (d) execute the selected subset according to a module invocation sequence stored in memory as an ordered data structure comprising at least one of an array, table, or linked data structure defining execution order of the selected modules; (e) compute, during execution, an updated governance coefficient based on at least one detected compliance or performance condition; (f) modify, based on the updated governance coefficient, at least one processor-controlled scheduling parameter by rewriting at least a portion of the ordered data structure stored in memory to alter module invocation order, module activation state, or output gating condition; and (g) continue execution of the task input under the modified scheduling parameter without terminating the task input, wherein the governance coefficient directly alters processor-controlled module routing during runtime.

2. The system of claim 1, wherein the governance-weighted decision logic is implemented using the governance weight record stored in memory.

3. The system of claim 2, wherein the governance weight record comprises fields including the compliance coefficient and the risk threshold.

4. The system of claim 2, wherein the governance weight record further comprises a jurisdiction indicator or an override state.

5. The system of claim 1, wherein the processor-controlled scheduling parameter comprises the module invocation order stored in memory.

6. The system of claim 1, wherein the processor-controlled scheduling parameter comprises the module activation state stored in memory.

7. The system of claim 1, wherein the processor-controlled scheduling parameter comprises the output gating condition stored in memory.

8. The system of claim 1, wherein rewriting comprises reordering module identifiers within an array stored in memory.

9. The system of claim 1, wherein rewriting comprises inserting a supplemental module identifier into the ordered data structure stored in memory.

10. The system of claim 1, wherein rewriting comprises clearing an activation flag to disable a module within the ordered data structure.

11. The system of claim 1, wherein the governance coefficient is recalculated at least once during execution of the task input.

12. The system of claim 11, wherein the governance coefficient is recalculated while at least one module of the selected subset remains active.

13. The system of claim 1, wherein the detected compliance condition comprises a comparison of the governance coefficient to a predefined threshold value stored in memory.

14. The system of claim 1, wherein the detected performance condition comprises a deviation in latency, error rate, or output confidence value.

15. The system of claim 1, wherein modifying the execution pathway comprises reordering the selected subset of modules.

16. The system of claim 1, wherein modifying the execution pathway comprises invoking at least one supplemental module.

17. The system of claim 1, wherein the orchestration controller transitions between execution states comprising a normal execution state and a restructuring state.

18. The system of claim 17, wherein the restructuring state is triggered in response to a detected deviation in compliance or performance metrics.

19. The system of claim 1, further comprising a human review interface configured to receive intermediate outputs.

20. The system of claim 19, wherein the orchestration controller modifies subsequent execution behavior based on feedback received from a human reviewer.

21. The system of claim 19, wherein escalation to the human review interface is triggered when a governance coefficient exceeds a predefined threshold.

22. The system of claim 1, wherein the orchestration controller validates an output according to at least one governance criterion prior to output propagation.

23. The system of claim 22, wherein validated outputs are associated with provenance metadata.

24. The system of claim 23, wherein the provenance metadata includes an execution timestamp and a module sequence identifier.

25. The system of claim 23, wherein the provenance metadata is stored in a secure audit record.

26. The system of claim 1, wherein at least two modules are concurrently active.

27. The system of claim 26, wherein concurrently active modules execute in overlapping time intervals.

28. The system of claim 1, wherein conflicting outputs generated by different modules are resolved using governance-weighted prioritization.

29. The system of claim 1, wherein propagation of an output is prevented when governance criteria cannot be satisfied.

30. The system of claim 1, wherein the orchestration controller enters a restricted-output state upon detection of a governance violation.

31. A computer-implemented orchestration system comprising: one or more processors; memory storing instructions executable by the one or more processors; and a plurality of artificial intelligence modules configured to perform computational tasks, wherein execution of the instructions causes the one or more processors to: (a) receive a task input; (b) generate a governance coefficient associated with the task input; (c) execute at least two of the plurality of artificial intelligence modules according to an ordered invocation structure stored in memory; (d) during execution of the task input, update the governance coefficient based on at least one detected compliance or performance condition; (e) modify, in memory and during execution of the task input, at least one scheduling parameter that controls module invocation; and (f) continue execution of the task input under the modified scheduling parameter without terminating execution, wherein the governance coefficient functions as a control-plane variable that alters processor-controlled module routing during runtime.

32. The system of claim 31, wherein the ordered invocation structure is stored as an ordered data structure in memory.

33. The system of claim 32, wherein the ordered data structure comprises at least one of an array, table, or linked data structure.

34. The system of claim 31, wherein modifying the scheduling parameter comprises altering an execution order value stored in memory or updating a module activation state stored in memory.

35. A non-transitory computer-readable medium storing instructions that, when executed by one or more processors, cause the processors to perform the operations of claim 31.
